(19) United States
(12) Patent Application Publication
(10) Pub. No.: US 2023/0039485 A1
(43) Pub. Date: Feb. 9, 2023

(54) IDENTIFYING AND PROVIDING ALTERNATIVE EQUIPMENT USING DIGITAL TWINS

(71) Applicant: International Business Machines Corporation, Armonk, NY (US)

(72) Inventors: Venkata Vara Prasad Karri, (US); Sarbajit K. Rakshit, Kolkata (IN); Kamal Kiran Trood Yamala, Visakhapatnam (IN); Surya Chandra Rao Jvvnn Kandregula, Visakhapatnam (IN)

(21) Appl. No.: 17/394,646

(22) Filed: Aug. 5, 2021

(51) Int. Cl. G05B 19/4099

(52) U.S. Cl. CPC G05B 19/4099; G05B 2219/49023

(57) ABSTRACT

A computer-implemented method, system and computer program product for identifying and providing alternative equipment. A digital representation of an equipment used for a user-designated purpose from a digital twin library is identified and selected by a user as corresponding to equipment requiring an alternative. Physical and functional properties of the equipment are then identified from a record of the identified digital representation in the digital twin library. Furthermore, other digital representations of corresponding candidates from the digital twin library are identified to provide an alternative to the equipment based on the user-designated purpose. A three-dimensional printing of one or more of these candidates, including modifications to the physical and/or functional properties of the candidates to function similar to the equipment that needs an alternative, is then performed and provided to the user as alternatives to the equipment.

### TECHNICAL FIELD

The present disclosure relates generally to equipment selection assistance apparatuses, and more particularly to identifying and providing alternative equipment using digital twins.

### BACKGROUND

There may be times in which demand for particular equipment (e.g., ventilator) exceeds the current supply for that equipment, especially during an unexpected event (e.g., pandemic). In such times, usually there is a desperate attempt to obtain such equipment in limited supply prior to other individuals.

Unfortunately, in such situations, those that are unable to obtain such equipment may have to forgo using such equipment or attempt to find alternatives.

### SUMMARY

In one embodiment of the present disclosure, a computer-implemented method for identifying and providing alternative equipment comprises identifying a digital representation of an equipment used for a user-designated purpose from a digital twin library which is selected by a user as corresponding to equipment requiring an alternative. The method further comprises identifying physical and functional properties of the equipment from a record of the identified digital representation in the digital twin library. The method additionally comprises identifying one or more other digital representations of corresponding one or more candidates from the digital twin library to provide an alternative to the equipment based on the user-designated purpose. Furthermore, the method comprises modifying physical and/or functional properties of one or more of the one or more candidates to be within a threshold degree of similarity of the physical and functional properties of the equipment. Additionally, the method comprises performing a three-dimensional printing of at least a portion of the one or more candidates using the modified physical and/or functional properties.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the alternative solution identifier used to identify and provide alternative equipment in accordance with an embodiment of the present disclosure;

FIG. 3 illustrates an embodiment of the present disclosure of the hardware configuration of the alternative solution identifier which is representative of a hardware environment for practicing the present disclosure; and

FIGS. 4A-4B are a flowchart of a method for identifying and providing alternative equipment in accordance with an embodiment of the present disclosure.

### DETAILED DESCRIPTION

As stated in the Background section, there may be times in which demand for particular equipment (e.g., ventilator) exceeds the current supply for that equipment, especially during an unexpected event (e.g., pandemic). In such times, usually there is a desperate attempt to obtain such equipment in limited supply prior to other individuals.

Unfortunately, in such situations, those that are unable to obtain such equipment may have to forgo using such equipment or attempt to find alternatives.

Currently, tools for selecting equipment, such as equipment selection assistance apparatuses, assist the users in selecting equipment to meet certain demands, such as reducing the peak of power consumption. For example, such apparatuses may be used to select the electrical equipment in a manner that limits power usage by predicting power consumption in equipment based on changes in power consumption in a demand time period.

While such tools are helpful in selecting equipment based on meeting certain demands, such tools fail to provide assistance to the user for selecting alternative equipment, such as during times in which the desired equipment cannot be obtained.

The embodiments of the present disclosure provide a means for identifying and providing an alternative (alternative equipment) to equipment, such as equipment in limited supply, based on identifying such alternative equipment from a digital twin library and providing such alternative equipment with possible modifications using three-dimensional printing.

In some embodiments of the present disclosure, the present disclosure comprises a computer-implemented method, system and computer program product for identifying and providing alternative equipment. In one embodiment of the present disclosure, a digital representation of an equipment that is used for a user-designated purpose is identified and selected by a user from a digital twin library as corresponding to the equipment requiring an alternative. Such a digital representation corresponds to a “digital twin.” A “digital twin,” as used herein, refers to a digital representation of a physical object or system. For example, the digital twin may consist of a digital representation of a physical object, such as equipment, a building, a factory or a city. In one embodiment, such digital twins have corresponding digital records stored in a digital twin library that includes use of purpose. After matching a user-provided use of purpose in one or more digital records, the associated digital representations are presented to the user. Out of these digital representations, the user selects the one which corresponds to the equipment that needs an alternative, such as equipment that is in limited supply. Physical and functional properties of the selected equipment are then identified from a record of the identified digital representation in the digital twin library. Furthermore, other digital representations from the digital twin library are identified corresponding to one or more candidates (candidates for being an alternative to the selected equipment) to provide an alternative to the selected equipment based on the user-designated purpose. For example, such candidates may be identified based on identifying a purpose of use that is similar to the user-designated purpose in the digital records of the digital twins of such candidates stored in the digital twin library. The physical and/or functional properties for at least a portion of such candidates obtained from such digital records are modified to be within a threshold degree of similarity to the physical and functional properties of the equipment that needs an alternative. A three-dimensional printing of such candidates using the modified physical and/or functional properties is then performed and provided to the user as alternatives to the equipment. In this manner, alternatives for equipment, such as equipment in limited supply, are identified and provided based on identifying such alternative equipment from a digital twin library and providing such alternative equipment with possible modifications using three-dimensional printing.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

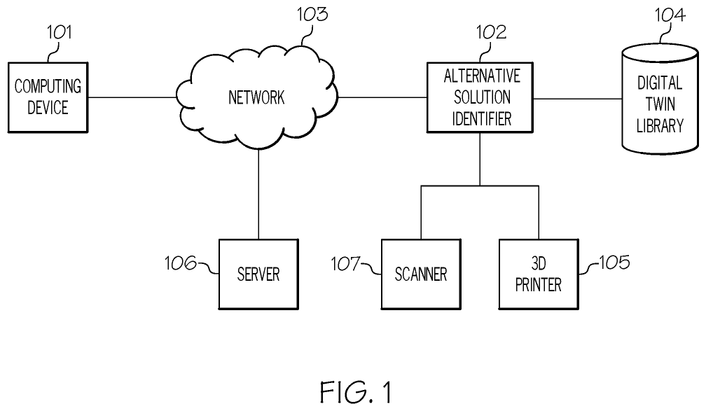

Referring now to the Figures in detail, FIG. 1 illustrates an embodiment of the present disclosure of a communication system 100 for identifying and providing an alternative (alternative equipment) to equipment, such as equipment in limited supply, in accordance with an embodiment of the present disclosure. As shown in FIG. 1, communication system 100 includes a computing device 101 utilized by a user to communicate with alternative solution identifier 102 via a network 103. It is noted that both computing device 101 and the user of computing device 101 may be identified with element number 101.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and alternative solution identifier 102.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

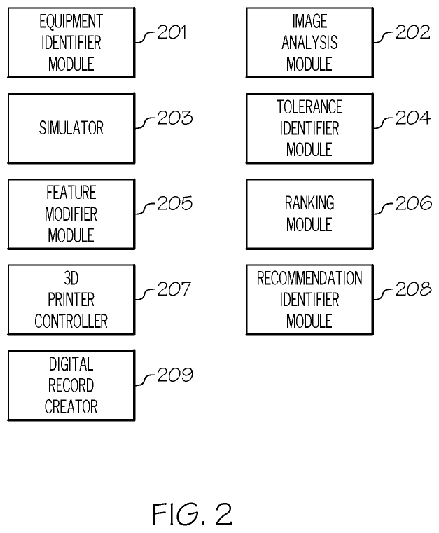

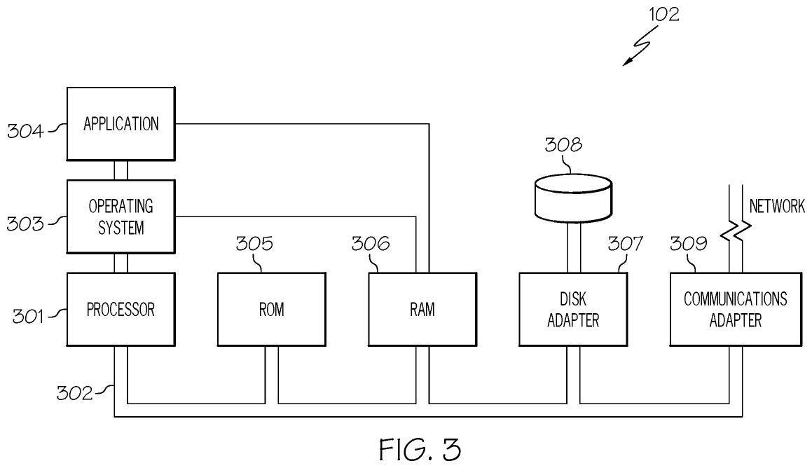

Furthermore, as shown in FIG. 1, system 100 includes alternative solution identifier 102, which is configured to identify and provide an alternative (alternative equipment) to equipment, such as equipment in limited supply, based on identifying such alternative equipment from a digital twin library 104 and providing such alternative equipment with possible modifications using three-dimensional printing performed by a three-dimensional (3D) printer 105. A description of the software components of alternative solution identifier 102 used to identify and provide alternative equipment is provided below in connection with FIG. 2. A description of the hardware configuration of alternative solution identifier 102 is provided further below in connection with FIG. 3.

In one embodiment, digital twin library 104 and 3D printer 105 are connected to alternative solution identifier 102.

A “digital twin,” as used herein, refers to a digital representation of a physical object or system. For example, the digital twin may consist of a digital representation of a physical object, such as equipment, a building, a factory or a city. In one embodiment, physical properties (e.g., shape, contour, dimension, hardness, temperature) and functional properties (e.g., vapor and gas removing, particulate removing, steering control, etc.) along with purposes of usage (e.g., cutting trees, repairing pipes, constructions, small demolitions, etc.) for such digital twins are stored in digital records that are contained within digital twin library 104.

In one embodiment, additional information may be stored in such digital records, such as a tolerance range, indicating the upper and lower specification limits. For example, the digital record may include the upper and lower limits for the physical properties as well as the upper and lower limits for the functional properties yet still be able to perform its intended purpose. In one embodiment, such information may be obtained by alternative solution identifier 102 by performing an online search for the tolerance range of the physical and functional properties for the physical objects and systems represented by the digital twins in digital twin library 104, such as via network 103, where such material is provided by a server 106 connected to network 103.

Furthermore, as discussed above, system 100 includes a 3D printer 105 configured to use any type of 3D printing process, such as vat photopolymerization, inkjet technology, binder jetting, powder bed fusion, material extrusion, directed energy deposition, and sheet lamination. Examples of 3D printers 105, include, but not limited to, Dremel® DigiLab 3d45 3D printer, Ultimaker S5, LulzBot® Mini 2, MakerBot® Replicator+, etc.

In one embodiment, server 106 is configured to host websites (website is a collection of relevant webpages that is addressed to a Uniform Resource Locator (URL)) and serve contents to the World Wide Web. For example, server 106 may host a website in which its collection of relevant webpages are accessed by alternative solution identifier 102. Furthermore, server 106 is configured to process incoming network requests over HTTP (Hypertext Transfer Protocol) and several other related protocols.

Additionally, as shown in FIG. 1, system 100 includes a dimensional scanner 107 connected to alternative solution identifier 102. In one embodiment, scanner 107 is configured to gather two-dimensional (2D) or three-dimensional (3D) information about an object, such as equipment. In one embodiment, scanner 107 converts the physical entity of the object into computer-aided engineering (CAE) data which allows for streamlined part analysis, precision dimensional measurement, etc. Scanning tasks include, but not limited to, dimensional measurement, two- or three-dimensional profiling, determining object orientation, depth mapping, digitizing and shaft measurement, etc. Scanner 107 may incorporate any of the following methods for dimensional scanning of a physical object (e.g., equipment): laser scanning, white light scanning, photogrammetry and videogrammetry, coordinate measuring machines, etc. Examples of scanner 107 include Afinia® EinScan-SE Elite, Creality® CR-T 3D scanner, SOL 3D scanner, XYZprinting® 3D Scanner Pro, HE3D® Ciclop Rotational Laser Scanner, etc.

System 100 is not to be limited in scope to any one particular network architecture. System 100 may include any number of computing devices 101, alternative solution identifiers 102, networks 103, digital twin libraries 104, 3D printers 105, servers 106 and scanners 107.

A discussion regarding the software components used by alternative solution identifier 102 to identify and provide alternative equipment is discussed below in connection with FIG. 2.

Referring to FIG. 2, in conjunction with FIG. 1, alternative solution identifier 102 includes an equipment identifier module 201 configured to identify a digital representation (digital twin) of an equipment used for a user-designated purpose from digital twin library 104.

In one embodiment, equipment identifier module 201 receives the purpose of an equipment that needs an alternative, such as equipment that is currently in limited supply, from a user of computing device 101, such as by the user entering such information via a user interface of computing device 101. For example, the user may be interested in identifying alternatives for N95 respirators. As a result, the user would enter the purpose of protection from both airborne and fluid hazards, such as splashes, sprays, etc.

Equipment identifier module 201 is configured to perform natural language processing to identify any digital records in digital twin library 104 that contain such terms, such as protection from airborne and fluid hazards. Any records, including its associated digital representation (digital twin), may be identified and presented to the user of computing device 101, such as via the user interface of computing device 101, as the possible equipment of interest for which an alternative needs to be identified and provided. The user of computing device 101 may then select one of the presented digital representations as corresponding to the equipment that is in short supply in which an alternative needs to be identified and provided. In one embodiment, if the user does not select any of the presented digital representations, then equipment identifier module 201 performs a further search, such as using less keywords to broaden the scope of the search.

Alternatively, if the user does not supply information pertaining to the equipment that needs an alternative, then image analysis module 202 may perform an image analysis on the equipment that needs an alternative to determine its physical and functional properties by utilizing dimensional scanner 107.

As discussed above, dimensional scanner 107 gathers information about the equipment, such as the dimensional measurement, two- or three-dimensional profiling, object orientation, depth, shaft measurement, etc. Such information is used to determine the equipment's physical and functional properties, which may be mapped to a digital record of a digital representation (digital twin) of the equipment stored in digital twin library 104. In one embodiment, equipment identifier module 201 utilizes natural language processing to identify such learned physical and functional properties in the digital records stored in digital twin library 104. The digital representations (digital twins) associated with the digital records that include the physical and functional properties that match within a threshold degree of similarity to the learned physical and functional properties of the equipment that needs an alternative are identified and presented to the user as discussed above.

Equipment identifier module 201 is further configured to identify other digital representations (digital twins) of equipment from digital twin library 104 that can be used for the same user-designated purpose. In one embodiment, such an identification is based on identifying digital representations (digital twins) of equipment with the same purpose as indicated in the digital record of the equipment that needs an alternative. In one embodiment, equipment identifier module 201 utilizes natural language processing to identify a matching user-designated purpose in the digital records of the digital twins stored in digital twin library 104. In one embodiment, equipment identifier module 201 utilizes natural language processing to identify alternative terms to the user-designated purpose to identify a larger pool of candidates. For example, if the user-designated purpose is to provide protection from both airborne and fluid hazards, then equipment identifier module 201 may utilize natural language processing to identify alternative terms, such as defense or guard against aerial and liquid dangers.

Alternative solution identifier 102 further includes a simulator 203 for simulating the functional and working behavior of the digital representation (digital twin) of the equipment based on the digital record of the equipment. For example, simulator 203 is configured to simulate the functional and working behavior of the digital representation of the equipment based on its physical and functional properties as indicated in the digital record associated with the digital representation of the equipment. In one embodiment, simulator 203 utilizes the SIMULIA® simulation tool by Dassault Systemes.

In another embodiment, simulator 203 performs a discrete element method (DEM) simulation by first generating a model, which results in spatially orienting all particles and assigning an initial velocity. The forces which act on each particle are computed from the initial data and the relevant physical laws and contact models. In one embodiment, the following forces are considered in macroscopic simulations: friction, when two particles touch each other; contact plasticity, or recoil, when two particles collide; gravity, the force of attraction between particles due to their mass; and attractive potentials, such as cohesion, adhesion, liquid bridging, and electrostatic attraction.

In another embodiment, the following forces are considered on a molecular level, such as the Coulomb force, the electrostatic attraction or repulsion of particles carrying electric charge; Pauli repulsion, when two atoms approach each other closely; and van der Waals force. All these forces are added up to find the total force acting on each particle. An integration method is employed to compute the change in the position and the velocity of each particle during a certain time step from Newton's laws of motion. Then, the new positions are used to compute the forces during the next step, and this loop is repeated until the simulation ends.

In one embodiment, an integration method that is used in the discrete element method is one of the following: the Verlet algorithm, velocity Verlet, symplectic integrators, and the leapfrog method.

Other types of simulation tools utilized by simulator 203 to simulate the functionality of the equipment based on the physical and functional properties of the equipment include SimScale®, OnScale® Solve, Simcad Pro, SIMUL8®, Matlab®, AnyLogic®, Unreal Engine®, etc.

Furthermore, in one embodiment, simulator 203 is configured to simulate the alternative solution (i.e., a candidate equipment with modifications to serve as the alternative to the equipment, such as equipment in short supply) in the same manner as simulating the functional and working behavior of the digital representation of the equipment selected by the user to find an alternative as discussed above. A “candidate” or “candidate equipment,” as used herein, refers to a possible alternative for the equipment, such as equipment that is in short supply, which may include modifications to the physical and functional parameters.

In one embodiment, such simulations involve altering the physical and functional properties, such as the physical and functional properties of the candidate, in attempt to identify alternative equipment that functions substantially similar to the equipment that the user has indicated needs an alternative. In one embodiment, such alternative equipment is identified based on identifying physical and functional properties that are within a threshold degree (which may be user-designated) of variance to the physical and functional properties of the equipment that the user has indicated needs an alternative.

Alternative solution identifier 102 further includes tolerance identifier module 204 configured to identify the tolerance range of the physical and functional properties of the equipment identified by the user (user of computing device 101) as needing an alternative. In one embodiment, such information may already be provided in the digital record of the digital representation of the equipment that needs an alternative. In such an embodiment, tolerance identifier module 204 utilizes natural language processing to identify such information from the digital record of the digital representation of the appropriate equipment in digital twin library 104.

Furthermore, tolerance identifier module 204 identifies the tolerance range of the physical and functional properties of the candidates for providing an alternative to the equipment selected by the user as needing an alternative in the same manner as discussed above.

Alternatively, tolerance identifier module 204 identifies such a tolerance range by having simulator 203 simulate the performance of the digital representation (digital twin) of the equipment that needs an alternative. In one embodiment, simulator 203 utilizes the physical and functional properties of the equipment that needs an alternative as indicated in its digital record in digital twin library 104 to determine its tolerance range. For example, simulator 203 may simulate the functionality of the equipment using various values for the physical and functional properties of the equipment. For instance, simulator 203 may simulate the equipment using the output range of 1400 horse power to 1700 horse power to determine if the equipment is still functioning correctly using such variations. If so, then simulator 203 may extend the output range from 1300 horse power to 1800 horse power and so forth until identifying the output range limit at which the equipment no longer functions properly. In one embodiment, such learned information may be stored in the digital record associated with the digital representation (digital twin) of the equipment.

Furthermore, tolerance identifier module 204 identifies the tolerance range of the physical and functional properties for the candidates in the same manner as discussed above.

Alternative solution identifier 102 further includes a feature modifier module 205 configured to modify the physical and functional properties of the candidates (possible alternatives to the equipment) to such a degree to be within a threshold degree of similarity to the physical and functional properties of the equipment that needs an alternative. As discussed above, simulator 203 is configured to determine the tolerance range of the physical and functional properties of the candidates. If the physical and functional properties of the candidates can be modified to be within a threshold degree of similarity to the physical and functional properties of the equipment that needs an alternative and yet still be within its tolerance range, then feature modifier module 205 may proceed with modifying the physical and functional properties of the candidates as may be indicated in the digital record of the digital representations (digital twins) of such candidates that are stored in digital twin library 104.

For example, feature modifier module 205 may determine if the tolerance range for the physical and functional properties of the candidates is within a threshold degree of similarity to the tolerance range for the physical and functional properties of the equipment that needs an alternative. For instance, if simulator 203 determines that the output range for the equipment that needs an alternative is between 1300 horse power and 1700 horse power, and simulator 203 also determines that the output range for one of the candidates is between 1200 horse power and 1800 horse power, then such a candidate will be deemed to satisfy the tolerance range for the output range of the equipment that needs an alternative. In another example, if simulator 203 determines that the output range for the equipment that needs an alternative is between 1.2 volts and 1.3 volts, and simulator 203 also determines that the output range for one of the candidates is between 1.0 volt and 1.14 volts, then such a candidate may be deemed to be within the threshold degree of similarity to the tolerance range for the output voltage of the equipment that needs an alternative if the threshold degree of similarity is 80%.

Furthermore, alternative solution identifier 102 includes a ranking module 206 configured to rank the candidates based on how close they can be converted to the equipment that needs an alternative in terms of physical and functional properties, time for modification and quantity available.

In one embodiment, ranking module 206 assigns a score to the digital representations (digital twins) of such candidates based on the factors discussed above. In one embodiment, such a score is normalized between the values of 0 and 1. In one embodiment, the higher the score, the higher the rank.

In one embodiment, ranking module 206 determines how close the candidate can be converted (modified) to the equipment that needs an alternative based on how close the tolerance range of the modified physical and functional properties of the candidates are to the tolerance range of the physical and functional properties of the equipment which needs an alternative. In one embodiment, the closer that the values of such physical and functional properties are, the higher the score.

In one embodiment, the “time for modification,” as used herein, refers to an estimated length of time to modify the candidates to have its physical and functional properties be within a threshold degree of similarity as the physical and functional properties of the equipment which needs an alternative. In one embodiment, such information is inputted to alternative solution identifier 102 by an expert.

In one embodiment, the time for modification is determined by ranking module 206 using a machine learning algorithm (e.g., supervised learning) to build a mathematical model based on sample data consisting of modifications (e.g., changes in physical and functional properties) to various equipment and the time to make such modifications. Such data may be obtained and tabulated by experts, who in turn, utilize such information to develop the sample data. Such a data set is referred to herein as the “training data” which is used by the machine learning algorithm to make predictions or decisions without being explicitly programmed to perform the task. In one embodiment, the training data consists of modifications (e.g., changes in physical and functional properties) to various equipment and the associated time to make such modifications. The algorithm iteratively makes predictions on the training data and is corrected by the expert until the predictions achieve the desired accuracy. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the time for modification.

In one embodiment, the “quantity available,” as used herein, refers to an estimated quantity of candidates that could be available to be purchased as an alternative to the equipment, such as equipment that is in short supply. In one embodiment, such information is inputted to alternative solution identifier 102 by an expert.

In one embodiment, the quantity available is determined by ranking module 206 using a machine learning algorithm (e.g., supervised learning) to build a mathematical model based on sample data consisting of quantity available of equipment after making modifications (e.g., changes in physical and functional properties) to such equipment. Such data may be obtained and tabulated by experts, who in turn, utilize such information to develop the sample data. Such a data set is referred to herein as the “training data” which is used by the machine learning algorithm to make predictions or decisions without being explicitly programmed to perform the task. In one embodiment, the training data consists of quantity available of equipment after making modifications (e.g., changes in physical and functional properties) to such equipment. The algorithm iteratively makes predictions on the training data and is corrected by the expert until the predictions achieve the desired accuracy. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the quantity available of equipment after making modifications (e.g., changes in physical and functional properties) to such equipment.

Referring again to FIG. 2, alternative solution identifier 102 further includes a 3D printer controller 207 configured to control 3D printer 105 in a manner that allows 3D printer 105 to perform three-dimensional (3D) printing of particular candidates based on their ranking (see above). For example, 3D printer controller 207 may instruct 3D printer 105 to perform 3D printing only for those candidates that are ranked in the top three.

Furthermore, as discussed above, image analysis module 202 may perform an image analysis on the equipment that needs an alternative to determine its physical and functional properties by utilizing dimensional scanner 107. Image analysis module 202 may further perform an image analysis on the 3D printed equipment using scanner 107 to identify any differences in the physical and functional properties of the 3D printed equipment with respect to the physical and functional properties of the equipment that needs an alternative.

In one embodiment, dimensional scanner 107 gathers information about the 3D printed equipment, such as the dimensional measurement, two- or three-dimensional profiling, object orientation, depth, shaft measurement, etc. Such information is used to determine the 3D printed equipment's physical and functional properties, which may be mapped to a digital record of a digital representation (digital twin) of the equipment stored in digital twin library 104. Such features are then compared with the features of the equipment that needs an alternative to identify such differences. After identifying such differences, recommendation identifier module 208 is configured to generate recommendations to address such differences.

In one embodiment, such differences are identified by image analysis module 202 based on analyzing the differences in the values associated with such physical and functional properties. For example, the physical property of the dimension of the 3D printed equipment (e.g., snorkeling mask) corresponds to the dimension of 7.9 inches in width and 10.2 inches in height. The physical property of the dimension of the equipment (e.g., ventilation mask) that needs an alternative corresponds to the dimension of 7.5 inches in width and 9.3 inches in height. After identifying such differences, recommendation identifier 208 generates a recommendation (e.g., utilize three-point, set and forget headgear from Teleflex®) to address such differences.

In one embodiment, recommendation identifier 208 generates such a recommendation based on input received by an expert.

In one embodiment, such a recommendation is determined by recommendation identifier module 208 using a machine learning algorithm (e.g., supervised learning) to build a mathematical model based on sample data consisting of recommendations (e.g., add additional layer of silicone for improving seal, replace stainless steel material with plastic material to lessen weight) to address such differences in physical and functional properties. Such data may be obtained and tabulated by experts, who in turn, utilize such information to develop the sample data. Such a data set is referred to herein as the “training data” which is used by the machine learning algorithm to make predictions or decisions without being explicitly programmed to perform the task. In one embodiment, the training data consists of recommendations to address such differences in physical and functional properties. The algorithm iteratively makes predictions on the training data and is corrected by the expert until the predictions achieve the desired accuracy. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the recommendation.

Additionally, alternative solution identifier 102 includes a digital record creator 209 configured to create or modify digital records for each digital representation (digital twin) of equipment that was constructed using 3D printing. Such digital records may also include any pertinent recommendations generated by recommendation identifier module 208 involving recommendations for addressing the differences in the physical and functional properties between the 3D printed equipment and the equipment for which the 3D printed equipment is to be the alternative equipment.

In one embodiment, such digital records reside within digital twin library 104.

In one embodiment, digital record creator 209 receives a performance report on the 3D printed equipment and the recommendations addressing the differences in the physical and functional properties between the 3D printed equipment and the equipment that needs an alternative. Such a performance report may involve the efficacy of the alternative solution, such as how well the alternative equipment is performing in comparison to the design of the equipment that needs an alternative. In one embodiment, such a performance report is provided by an expert.

In one embodiment, such an analysis (how well the alternative equipment is performing in comparison to the design of the equipment that needs an alternative) may be performed by simulator 203 in which simulator 203 simulates the functionality of both the alternative equipment and the equipment that needs an alternative and details the differences in functionality. Such an analysis may be performed by simulator 203 using various simulation tools, such as SIMULIA® by Dassault Systemes, SimScale®, OnScale® Solve, Simcad Pro, SIMUL8®, Matlab®, AnyLogic®, Unreal Engine®, etc. Furthermore, such an analysis may be performed by simulator 203 using the discrete element method (DEM) simulation as discussed above. The results of such a simulation may be provided in a performance report, which is made available to digital record creator 209.

Upon receipt of the performance report, digital record creator 209 may store such a performance record in the appropriate digital record, i.e., within the digital record for the alternative equipment.

A further description of these and other functions is provided below in connection with the discussion of the method for identifying and providing alternatives to equipment, such as equipment in limited supply.

Prior to the discussion of the method for identifying and providing alternatives to equipment, such as equipment in limited supply, a description of the hardware configuration of alternative solution identifier 102 (FIG. 1) is provided below in connection with FIG. 3.

Referring now to FIG. 3, FIG. 3 illustrates an embodiment of the present disclosure of the hardware configuration of alternative solution identifier 102 (FIG. 1) which is representative of a hardware environment for practicing the present disclosure.

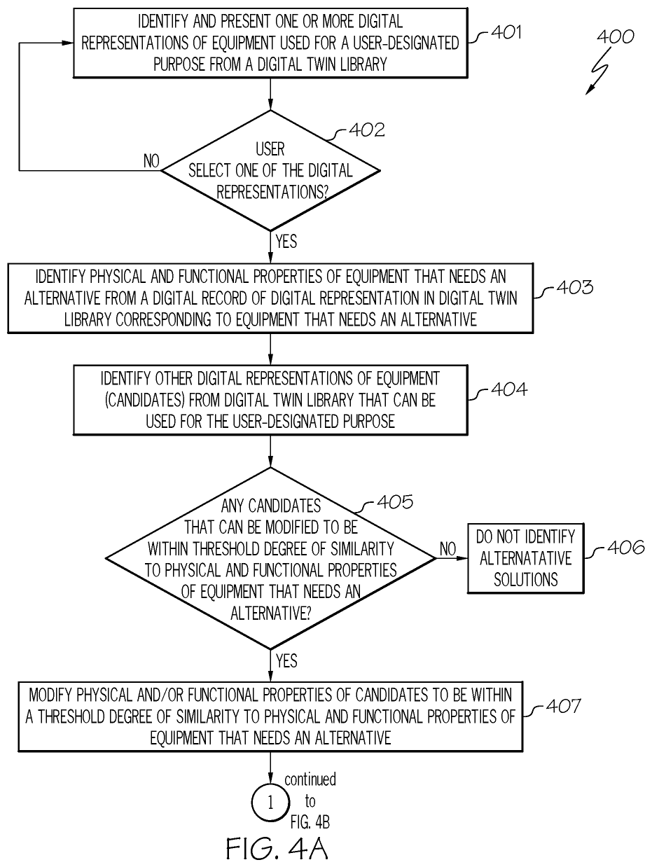

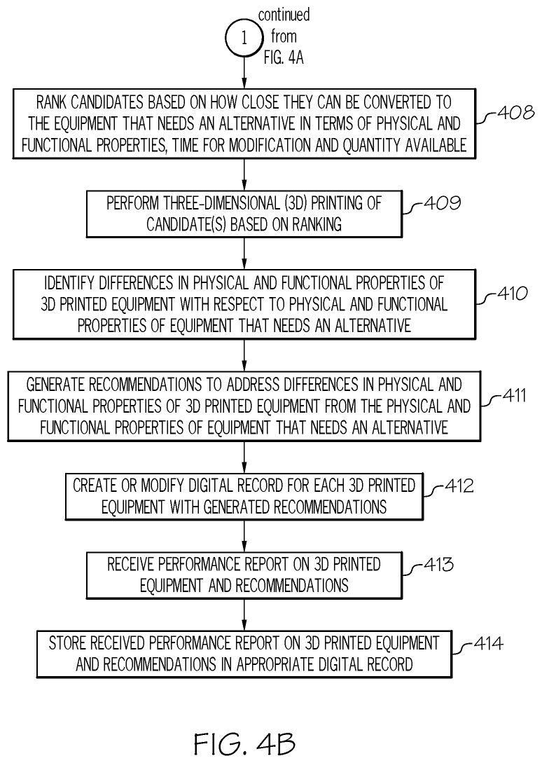

Alternative solution identifier 102 has a processor 301 connected to various other components by system bus 302. An operating system 303 runs on processor 301 and provides control and coordinates the functions of the various components of FIG. 3. An application 304 in accordance with the principles of the present disclosure runs in conjunction with operating system 303 and provides calls to operating system 303 where the calls implement the various functions or services to be performed by application 304. Application 304 may include, for example, equipment identifier module 201 (FIG. 2), image analysis module 202 (FIG. 2), simulator 203 (FIG. 2), tolerance identifier module 204 (FIG. 2), feature modifier module 205 (FIG. 2), ranking module 206 (FIG. 2), 3D printer controller 207 (FIG. 2), recommendation identifier module 208 (FIG. 2) and digital record creator 209 (FIG. 2). Furthermore, application 304 may include, for example, a program for identifying and providing alternatives to equipment, such as equipment in limited supply, as discussed further below in connection with FIGS. 4A-4B.

Referring again to FIG. 3, read-only memory (“ROM”) 305 is connected to system bus 302 and includes a basic input/output system (“BIOS”) that controls certain basic functions of alternative solution identifier 102. Random access memory (“RAM”) 306 and disk adapter 307 are also connected to system bus 302. It should be noted that software components including operating system 303 and application 304 may be loaded into RAM 306, which may be alternative solution identifier's 102 main memory for execution. Disk adapter 307 may be an integrated drive electronics (“IDE”) adapter that communicates with a disk unit 308, e.g., disk drive. It is noted that the program for identifying and providing alternatives to equipment, such as equipment in limited supply, as discussed further below in connection with FIGS. 4A-4B, may reside in disk unit 308 or in application 304.

Alternative solution identifier 102 may further include a communications adapter 309 connected to bus 302. Communications adapter 309 interconnects bus 302 with an outside network (e.g., network 103 of FIG. 1) to communicate with other devices, such as computing device 101 and server 106 of FIG. 1.

In one embodiment, application 304 of alternative solution identifier 102 includes the software components of equipment identifier module 201, image analysis module 202, simulator 203, tolerance identifier module 204, feature modifier module 205, ranking module 206, 3D printer controller 207, recommendation identifier module 208 and digital record creator 209. In one embodiment, such components may be implemented in hardware, where such hardware components would be connected to bus 302. The functions discussed above performed by such components are not generic computer functions. As a result, alternative solution identifier 102 is a particular machine that is the result of implementing specific, non-generic computer functions.

In one embodiment, the functionality of such software components (e.g., equipment identifier module 201, image analysis module 202, simulator 203, tolerance identifier module 204, feature modifier module 205, ranking module 206, 3D printer controller 207, recommendation identifier module 208 and digital record creator 209) of alternative solution identifier 102, including the functionality for identifying and providing alternatives to equipment, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, there may be times in which demand for particular equipment (e.g., ventilator) exceeds the current supply for that equipment, especially during an unexpected event (e.g., pandemic). In such times, usually there is a desperate attempt to obtain such equipment in limited supply prior to other individuals. Unfortunately, in such situations, those that are unable to obtain such equipment may have to forgo using such equipment or attempt to find alternatives. Currently, tools for selecting equipment, such as equipment selection assistance apparatuses, assist the users in selecting equipment to meet certain demands, such as reducing the peak of power consumption. For example, such apparatuses may be used to select the electrical equipment in a manner that limits power usage by predicting power consumption in equipment based on changes in power consumption in a demand time period. While such tools are helpful in selecting equipment based on meeting certain demands, such tools fail to provide assistance to the user for selecting alternative equipment, such as during times in which the desired equipment cannot be obtained.

The embodiments of the present disclosure provide a means for identifying and providing alternatives to equipment, such as equipment in limited supply, based on identifying such alternative equipment from a digital twin library and providing such alternative equipment with possible modifications using three-dimensional printing as discussed below in connection with FIGS. 4A-4B.

FIGS. 4A-4B are a flowchart of a method 400 for identifying and providing alternative equipment in accordance with an embodiment of the present disclosure.

Referring to FIG. 4A, in conjunction with FIGS. 1-3, in step 401, equipment identifier module 201 of alternative solution identifier 102 identifies and presents (such as to the user of computing device 101) one or more digital representations of equipment that are used for a user-designated purpose from digital twin library 104.

As discussed above, in one embodiment, equipment identifier module 201 receives the purpose of an equipment that needs an alternative, such as equipment that is currently in limited supply, from a user of computing device 101, such as by the user entering such information via a user interface of computing device 101. For example, the user may be interested in identifying alternatives for N95 respirators. As a result, the user would enter the purpose of protection from both airborne and fluid hazards, such as splashes, sprays, etc.

Equipment identifier module 201 is configured to perform natural language processing to identify any digital records in digital twin library 104 that contain such terms, such as protection from airborne and fluid hazards. Any records, including its associated digital representation (digital twin), may be identified and presented to the user of computing device 101, such as via the user interface of computing device 101, as the possible equipment of interest for which an alternative needs to be identified and provided. The user of computing device 101 may then select one of the presented digital representations as corresponding to the equipment that is in short supply in which an alternative needs to be identified and provided. In one embodiment, if the user does not select any of the presented digital representations, then equipment identifier module 201 performs a further search, such as using less keywords to broaden the scope of the search.

Alternatively, if the user does not supply information pertaining to the equipment that needs an alternative, then image analysis module 202 may perform an image analysis on the equipment that needs an alternative to determine its physical and functional properties by utilizing dimensional scanner 107.

As discussed above, dimensional scanner 107 gathers information about the equipment, such as the dimensional measurement, two- or three-dimensional profiling, object orientation, depth, shaft measurement, etc. Such information is used to determine the equipment's physical and functional properties, which may be mapped to a digital record of a digital representation (digital twin) of the equipment stored in digital twin library 104. In one embodiment, equipment identifier module 201 utilizes natural language processing to identify such learned physical and functional properties in the digital records stored in digital twin library 104. The digital representations (digital twins) associated with the digital records that include the physical and functional properties that match within a threshold degree of similarity to the learned physical and functional properties of the equipment that needs an alternative are identified and presented to the user as discussed above.

In step 402, a determination is made by equipment identifier module 201 of alternative solution identifier 102 as to whether the user selected one of the presented digital representations as the appropriate equipment that needs an alternative. As discussed above, the digital representations that were identified in step 401 may be presented to the user, such as to the user of computing device 101 via the user interface of computing device 101.

If the user does not select one of such presented digital representations, then equipment identifier module 201 continues to identify and present other digital representations of equipment that are used for a user-designated purpose from digital twin library 104 in step 401. For example, equipment identifier module 201 may identify alternative terms corresponding to the user-designated purpose using natural language processing. For example, if the user indicated that the user-designated purpose is to provide protection from both airborne and fluid hazards, then equipment identifier module 201 may utilize a thesaurus to identify alternative terms, such as defense or guard against aerial and liquid dangers.

If, on the other hand, the user selects one of such presented digital representations, then, in step 403, equipment identifier module 201 of alternative solution identifier 102 identifies the physical and functional properties of the equipment that needs an alternative from a digital record of the digital representation (digital twin) in digital twin library 104 corresponding to the equipment that needs an alternative. In one embodiment, equipment identifier module 201 utilizes natural language processing to extract such information from the digital record of the equipment that needs an alternative.

In step 404, equipment identifier module 201 of alternative solution identifier 102 identifies other digital representations of equipment (“candidates”) from digital twin library 104 that can be used for the user-designated purpose.

As discussed above, equipment identifier module 201 is configured to identify other digital representations (digital twins) of equipment from digital twin library 104 that can be used for the same user-designated purpose. In one embodiment, such an identification is based on identifying digital representations (digital twins) of equipment with the same purpose as indicated in the digital record of the equipment that needs an alternative. In one embodiment, equipment identifier module 201 utilizes natural language processing to identify a matching user-designated purpose in the digital records of the digital twins stored in digital twin library 104. In one embodiment, equipment identifier module 201 utilizes natural language processing to identify alternative terms to the user-designated purpose to identify a larger pool of candidates. For example, if the user-designated purpose is to provide protection from both airborne and fluid hazards, then equipment identifier module 201 may utilize natural language processing to identify alternative terms, such as defense or guard against aerial and liquid dangers.

In step 405, a determination is made by feature modifier module 205 of alternative solution identifier 102 as to whether the physical and functional properties of the identified other digital representations of equipment (“candidates”) can be modified to be within a threshold degree of similarity to the physical and functional properties of the equipment that needs an alternative.

As discussed above, tolerance identifier module 204 is configured to identify the tolerance range of the physical and functional properties of the equipment identified by the user (user of computing device 101) as needing an alternative. In one embodiment, such information may already be provided in the digital record of the digital representation of the equipment that needs an alternative. In such an embodiment, tolerance identifier module 204 utilizes natural language processing to identify such information from the digital record of the digital representation of the appropriate equipment in digital twin library 104.

Furthermore, tolerance identifier module 204 identifies the tolerance range of the physical and functional properties of the candidates for providing an alternative to the equipment selected by the user as needing an alternative in the same manner as discussed above.

Alternatively, tolerance identifier module 204 identifies such a tolerance range by having simulator 203 simulate the performance of the digital representation (digital twin) of the equipment that needs an alternative. In one embodiment, simulator 203 utilizes the physical and functional properties of the equipment that needs an alternative as indicated in its digital record in digital twin library 104 to determine its tolerance range. For example, simulator 203 may simulate the functionality of the equipment using various values for the physical and functional properties of the equipment. For instance, simulator 203 may simulate the equipment using the output range of 1400 horse power to 1700 horse power to determine if the equipment is still functioning correctly using such variations. If so, then simulator 203 may extend the output range from 1300 horse power to 1800 horse power and so forth until identifying the output range limit at which the equipment no longer functions properly. In one embodiment, such learned information may be stored in the digital record associated with the digital representation (digital twin) of the equipment.

Furthermore, tolerance identifier module 204 identifies the tolerance range of the physical and functional properties for the candidates in the same manner as discussed above.

As also discussed above, simulator 203 is configured to determine the tolerance range of the physical and functional properties of the candidates. If the physical and functional properties of the candidates can be modified to be within a threshold degree of similarity to the physical and functional properties of the equipment that needs an alternative and yet still be within its tolerance range, then feature modifier module 205 may proceed with modifying the physical and functional properties of the candidates as may be indicated in the digital record of the digital representations (digital twins) of such candidates that are stored in digital twin library 104.

In one embodiment, feature modifier module 205 is configured to instruct simulator 203 to modify the physical and functional properties of those candidates to determine if the physical and functional properties of any of the candidates is within a threshold degree of similarity to the physical and functional properties of the equipment that needs an alternative. For example, feature modifier module 205 may instruct simulator 203 to identify the tolerance range of the physical and functional properties of the candidates as discussed above.

For example, feature modifier module 205 may determine if the tolerance range for the physical and functional properties of the candidates is within a threshold degree of similarity to the tolerance range for the physical and functional properties of the equipment that needs an alternative. For instance, if simulator 203 determines that the output range for the equipment that needs an alternative is between 1300 horse power and 1700 horse power, and simulator 203 also determines that the output range for one of the candidates is between 1200 horse power and 1800 horse power, then such a candidate will be deemed to satisfy the tolerance range for the output range of the equipment that needs an alternative. In another example, if simulator 203 determines that the output range for the equipment that needs an alternative is between 1.2 volts and 1.3 volts, and simulator 203 also determines that the output range for one of the candidates is between 1.0 volt and 1.14 volts, then such a candidate may be deemed to be within the threshold degree of similarity to the tolerance range for the output voltage of the equipment that needs an alternative if the threshold degree of similarity is 80%.

If none of the candidates can be modified to be within a threshold degree of similarity to the physical and functional properties of the equipment that needs an alternative, then, in step 406, alternative solutions are not identified.

If, however, one or more of the candidates can be modified to be within a threshold degree of similarity to the physical and functional properties of the equipment that needs an alternative, then, in step 407, feature modifier module 205 modifies such physical and/or functional properties for those candidates to be within a threshold degree of similarity to the physical and functional properties of the equipment that needs an alternative.

As discussed above, in one embodiment, such modifications are indicated in the digital record for such candidates that are stored in digital twin library 104.

Referring now to FIG. 4B, in conjunction with FIGS. 1-3, in step 408, ranking module 206 of alternative solution identifier 102 ranks the candidates based on how close they can be converted to the equipment that needs an alternative in terms of physical and functional properties, time for modification and quantity available.

As stated above, in one embodiment, ranking module 206 assigns a score to the digital representations (digital twins) of such candidates based on the factors discussed above. In one embodiment, such a score is normalized between the values of 0 and 1. In one embodiment, the higher the score, the higher the rank.

In one embodiment, ranking module 206 determines how close the candidate can be converted (modified) to the equipment that needs an alternative based on how close the tolerance range of the modified physical and functional properties of the candidates are to the tolerance range of the physical and functional properties of the equipment which needs an alternative. In one embodiment, the closer that the values of such physical and functional properties are, the higher the score.

In one embodiment, the “time for modification,” as used herein, refers to an estimated length of time to modify the candidates to have its physical and functional properties be within a threshold degree of similarity as the physical and functional properties of the equipment which needs an alternative. In one embodiment, such information is inputted to alternative solution identifier 102 by an expert.

In one embodiment, the time for modification is determined by ranking module 206 using a machine learning algorithm (e.g., supervised learning) to build a mathematical model based on sample data consisting of modifications (e.g., changes in physical and functional properties) to various equipment and the time to make such modifications. Such data may be obtained and tabulated by experts, who in turn, utilize such information to develop the sample data. Such a data set is referred to herein as the “training data” which is used by the machine learning algorithm to make predictions or decisions without being explicitly programmed to perform the task. In one embodiment, the training data consists of modifications (e.g., changes in physical and functional properties) to various equipment and the associated time to make such modifications. The algorithm iteratively makes predictions on the training data and is corrected by the expert until the predictions achieve the desired accuracy. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the time for modification.

In one embodiment, the “quantity available,” as used herein, refers to an estimated quantity of candidates that could be available to be purchased as an alternative to the equipment, such as equipment that is in short supply. In one embodiment, such information is inputted to alternative solution identifier 102 by an expert.

In one embodiment, the quantity available is determined by ranking module 206 using a machine learning algorithm (e.g., supervised learning) to build a mathematical model based on sample data consisting of quantity available of equipment after making modifications (e.g., changes in physical and functional properties) to such equipment. Such data may be obtained and tabulated by experts, who in turn, utilize such information to develop the sample data. Such a data set is referred to herein as the “training data” which is used by the machine learning algorithm to make predictions or decisions without being explicitly programmed to perform the task. In one embodiment, the training data consists of quantity available of equipment after making modifications (e.g., changes in physical and functional properties) to such equipment. The algorithm iteratively makes predictions on the training data and is corrected by the expert until the predictions achieve the desired accuracy. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the quantity available of equipment after making modifications (e.g., changes in physical and functional properties) to such equipment.

In step 409, 3D printer controller 207 of alternative solution identifier 102 performs three-dimensional (3D) printing of the candidates based on their ranking.

As stated above, 3D printer controller 207 is configured to control 3D printer 105 in a manner that allows 3D printer 105 to perform three-dimensional (3D) printing of particular candidates based on their ranking. For example, 3D printer controller 207 may instruct 3D printer 105 to perform 3D printing only for those candidates that are ranked in the top three.

In step 410, image analysis module 202 of alternative solution identifier 102 identifies the differences in the physical and functional properties of the 3D printed equipment with respect to the physical and functional properties of the equipment that needs an alternative.

As discussed above, image analysis module 202 may perform an image analysis on the equipment that needs an alternative to determine its physical and functional properties by utilizing dimensional scanner 107. Image analysis module 202 may further perform an image analysis on the 3D printed equipment using scanner 107 to identify any differences in the physical and functional properties of the 3D printed equipment with respect to the physical and functional properties of the equipment that needs an alternative.

In one embodiment, dimensional scanner 107 gathers information about the 3D printed equipment, such as the dimensional measurement, two- or three-dimensional profiling, object orientation, depth, shaft measurement, etc. Such information is used to determine the 3D printed equipment's physical and functional properties, which may be mapped to a digital record of a digital representation (digital twin) of the equipment stored in digital twin library 104. Such features are then compared with the features of the equipment that needs an alternative to identify such differences. After identifying such differences, recommendation identifier module 208 is configured to generate recommendations to address such differences.

In one embodiment, such differences are identified by image analysis module 202 based on analyzing the differences in the values associated with such physical and functional properties. For example, the physical property of the dimension of the 3D printed equipment (e.g., snorkeling mask) corresponds to the dimension of 7.9 inches in width and 10.2 inches in height. The physical property of the dimension of the equipment (e.g., ventilation mask) that needs an alternative corresponds to the dimension of 7.5 inches in width and 9.3 inches in height. After identifying such differences, recommendation identifier 208 generates a recommendation (e.g., utilize three-point, set and forget headgear from Teleflex®) to address such differences.

In step 411, recommendation identifier module 208 of alternative solution identifier 102 generates recommendations to address the differences in the physical and functional properties of the 3D printed equipment from the physical and functional properties of the equipment that needs an alternative.

As discussed above, in one embodiment, such a recommendation is determined by recommendation identifier module 208 using a machine learning algorithm (e.g., supervised learning) to build a mathematical model based on sample data consisting of recommendations (e.g., add additional layer of silicone for improving seal, replace stainless steel material with plastic material to lessen weight) to address such differences in physical and functional properties. Such data may be obtained and tabulated by experts, who in turn, utilize such information to develop the sample data. Such a data set is referred to herein as the “training data” which is used by the machine learning algorithm to make predictions or decisions without being explicitly programmed to perform the task. In one embodiment, the training data consists of recommendations to address such differences in physical and functional properties. The algorithm iteratively makes predictions on the training data and is corrected by the expert until the predictions achieve the desired accuracy. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the recommendation.

In step 412, digital record creator 209 of alternative solution identifier 102 creates or modifies a digital record for each 3D printed equipment with the generated recommendations.

As discussed above, digital record creator 209 is configured to create or modify digital records for each digital representation (digital twin) of equipment that was constructed using 3D printing. Such digital records may also include any pertinent recommendations generated by recommendation identifier module 208 involving recommendations for addressing the differences in the physical and functional properties between the 3D printed equipment and the equipment for which the 3D printed equipment is to be the alternative equipment.

In step 413, digital record creator 209 of alternative solution identifier 102 receives a performance report on the 3D printed equipment and the recommendations.

As discussed above, in one embodiment, digital record creator 209 receives a performance report on the 3D printed equipment and the recommendations addressing the differences in the physical and functional properties between the 3D printed equipment and the equipment that needs an alternative. Such a performance report may involve the efficacy of the alternative solution, such as how well the alternative equipment is performing in comparison to the design of the equipment that needs an alternative. In one embodiment, such a performance report is provided by an expert.

In one embodiment, such an analysis (how well the alternative equipment is performing in comparison to the design of the equipment that needs an alternative) may be performed by simulator 203 in which simulator 203 simulates the functionality of both the alternative equipment and the equipment that needs an alternative and details the differences in functionality. Such an analysis may be performed by simulator 203 using various simulation tools, such as SIMULIA® by Dassault Systemes, SimScale®, OnScale® Solve, Simcad Pro, SIMUL8®, Matlab®, AnyLogic®, Unreal Engine®, etc. Furthermore, such an analysis may be performed by simulator 203 using the discrete element method (DEM) simulation as discussed above. The results of such a simulation may be provided in a performance report, which is made available to digital record creator 209.

In step 414, digital record creator 209 of alternative solution identifier 102 stores the received performance report on the 3D printed equipment and the recommendations in the appropriate digital record.

As a result of the foregoing, the embodiments of the present disclosure provide a means for identifying and providing alternatives to equipment, such as equipment in limited supply, based on identifying such alternative equipment from a digital twin library and providing such alternative equipment with possible modifications using three-dimensional printing.

Furthermore, the principles of the present disclosure improve the technology or technical field involving equipment selection assistance apparatuses. As discussed above, there may be times in which demand for particular equipment (e.g., ventilator) exceeds the current supply for that equipment, especially during an unexpected event (e.g., pandemic). In such times, usually there is a desperate attempt to obtain such equipment in limited supply prior to other individuals. Unfortunately, in such situations, those that are unable to obtain such equipment may have to forgo using such equipment or attempt to find alternatives. Currently, tools for selecting equipment, such as equipment selection assistance apparatuses, assist the users in selecting equipment to meet certain demands, such as reducing the peak of power consumption. For example, such apparatuses may be used to select the electrical equipment in a manner that limits power usage by predicting power consumption in equipment based on changes in power consumption in a demand time period. While such tools are helpful in selecting equipment based on meeting certain demands, such tools fail to provide assistance to the user for selecting alternative equipment, such as during times in which the desired equipment cannot be obtained.

Embodiments of the present disclosure improve such technology by identifying a digital representation of an equipment used for a user-designated purpose from a digital twin library which is selected by a user as corresponding to equipment requiring an alternative. Such a digital representation corresponds to a “digital twin.” A “digital twin,” as used herein, refers to a digital representation of a physical object or system. For example, the digital twin may consist of a digital representation of a physical object, such as equipment, a building, a factory or a city. In one embodiment, such digital twins have corresponding digital records stored in a digital twin library that includes use of purpose. After matching a user-provided use of purpose in one or more digital records, the associated digital representations are presented to the user. Out of these digital representations, the user selects the one which corresponds to the equipment that needs an alternative, such as equipment that is in limited supply. Physical and functional properties of the selected equipment are then identified from a record of the identified digital representation in the digital twin library. Furthermore, other digital representations from the digital twin library are identified corresponding to one or more candidates (candidates for being an alternative to the selected equipment) to provide an alternative to the selected equipment based on the user-designated purpose. For example, such candidates may be identified based on identifying a purpose of use that is similar to the user-designated purpose in the digital records of the digital twins of such candidates stored in the digital twin library. The physical and/or functional properties for at least a portion of such candidates obtained from such digital records are modified to be within a threshold degree of similarity to the physical and functional properties of the equipment that needs an alternative. A three-dimensional printing of such candidates using the modified physical and/or functional properties is then performed and provided to the user as alternatives to the equipment. In this manner, alternatives for equipment, such as equipment in limited supply, are identified and provided based on identifying such alternative equipment from a digital twin library and providing such alternative equipment with possible modifications using three-dimensional printing. Furthermore, in this manner, there is an improvement in the technical field involving equipment selection assistance apparatuses.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for identifying and providing alternative equipment, the method comprising:
identifying a digital representation of an equipment used for a user-designated purpose from a digital twin library which is selected by a user as corresponding to equipment requiring an alternative;
identifying physical and functional properties of said equipment from a record of said identified digital representation in said digital twin library;
identifying one or more other digital representations of corresponding one or more candidates from said digital twin library to provide an alternative to said equipment based on said user-designated purpose;
modifying physical and/or functional properties of one or more of said one or more candidates to be within a threshold degree of similarity of said physical and functional properties of said equipment; and
performing a three-dimensional printing of at least a portion of said one or more candidates using said modified physical and/or functional properties.

2. The method as recited in claim 1 further comprising:
ranking said one or more of said one or more candidates based on how close said physical and functional properties of said one or more of said one or more candidates are to said physical and functional properties of said equipment, a time for modification and a quantity available.

3. The method as recited in claim 2 further comprising:
performing said three-dimensional printing of at least said portion of said one or more candidates based on said ranking.

4. The method as recited in claim 1 further comprising:
identifying differences in physical and functional properties of a three-dimensional printed equipment with respect to said physical and functional properties of said equipment.

5. The method as recited in claim 4 further comprising:
generating recommendations to address said identified differences in physical and functional properties.

6. The method as recited in claim 5 further comprising:
creating or modifying a digital record for said three-dimensional printed equipment that comprises said physical and functional properties of said three-dimensional printed equipment and said associated recommendations.

7. The method as recited in claim 6 further comprising:
receiving a performance report on said three-dimensional printed equipment and said recommendations; and
storing said received performance report in said digital record for said three-dimensional printed equipment.

8. A computer program product for identifying and providing alternative equipment, the computer program product comprising one or more computer readable storage mediums having program code embodied therewith, the program code comprising programming instructions for:
identifying a digital representation of an equipment used for a user-designated purpose from a digital twin library which is selected by a user as corresponding to equipment requiring an alternative;
identifying physical and functional properties of said equipment from a record of said identified digital representation in said digital twin library;
identifying one or more other digital representations of corresponding one or more candidates from said digital twin library to provide an alternative to said equipment based on said user-designated purpose;
modifying physical and/or functional properties of one or more of said one or more candidates to be within a threshold degree of similarity of said physical and functional properties of said equipment; and
performing a three-dimensional printing of at least a portion of said one or more candidates using said modified physical and/or functional properties.

9. The computer program product as recited in claim 8, wherein the program code further comprises the programming instructions for:
ranking said one or more of said one or more candidates based on how close said physical and functional properties of said one or more of said one or more candidates are to said physical and functional properties of said equipment, a time for modification and a quantity available.

10. The computer program product as recited in claim 9, wherein the program code further comprises the programming instructions for:
performing said three-dimensional printing of at least said portion of said one or more candidates based on said ranking.

11. The computer program product as recited in claim 8, wherein the program code further comprises the programming instructions for:
identifying differences in physical and functional properties of a three-dimensional printed equipment with respect to said physical and functional properties of said equipment.

12. The computer program product as recited in claim 11, wherein the program code further comprises the programming instructions for:
generating recommendations to address said identified differences in physical and functional properties.

13. The computer program product as recited in claim 12, wherein the program code further comprises the programming instructions for:
creating or modifying a digital record for said three-dimensional printed equipment that comprises said physical and functional properties of said three-dimensional printed equipment and said associated recommendations.

14. The computer program product as recited in claim 13, wherein the program code further comprises the programming instructions for:
receiving a performance report on said three-dimensional printed equipment and said recommendations; and
storing said received performance report in said digital record for said three-dimensional printed equipment.

15. A system, comprising:
a memory for storing a computer program for identifying and providing alternative equipment; and
a processor connected to said memory, wherein said processor is configured to execute program instructions of the computer program comprising:
identifying a digital representation of an equipment used for a user-designated purpose from a digital twin library which is selected by a user as corresponding to equipment requiring an alternative;
identifying physical and functional properties of said equipment from a record of said identified digital representation in said digital twin library;
identifying one or more other digital representations of corresponding one or more candidates from said digital twin library to provide an alternative to said equipment based on said user-designated purpose;
modifying physical and/or functional properties of one or more of said one or more candidates to be within a threshold degree of similarity of said physical and functional properties of said equipment; and
performing a three-dimensional printing of at least a portion of said one or more candidates using said modified physical and/or functional properties.

16. The system as recited in claim 15, wherein the program instructions of the computer program further comprise:
ranking said one or more of said one or more candidates based on how close said physical and functional properties of said one or more of said one or more candidates are to said physical and functional properties of said equipment, a time for modification and a quantity available.

17. The system as recited in claim 16, wherein the program instructions of the computer program further comprise:
performing said three-dimensional printing of at least said portion of said one or more candidates based on said ranking.

18. The system as recited in claim 15, wherein the program instructions of the computer program further comprise:
identifying differences in physical and functional properties of a three-dimensional printed equipment with respect to said physical and functional properties of said equipment.

19. The system as recited in claim 18, wherein the program instructions of the computer program further comprise:
generating recommendations to address said identified differences in physical and functional properties.

20. The system as recited in claim 19, wherein the program instructions of the computer program further comprise:
creating or modifying a digital record for said three-dimensional printed equipment that comprises said physical and functional properties of said three-dimensional printed equipment and said associated recommendations.
